(19) United States
(12) Patent Application Publication
(10) Pub. No.: US 2007/0247477 A1
(43) Pub. Date: Oct. 25, 2007

(54) Method and apparatus for processing, displaying and viewing stereoscopic 3D images

(76) Inventors: Gregory N. Lowry, Victoria (CA); David L. Dlugos, Victoria (CA)

Correspondence Address: ABELMAN, FRAYNE & SCHWAB, 666 THIRD AVENUE, 10TH FLOOR, NEW YORK, NY, 10017, US

(21) Appl. No.: 11/788,429

(22) Filed: Apr. 20, 2007

Related U.S. Application Data
(60) Provisional application No. 60/794,277, filed on Apr. 21, 2006.

(51) Int. Cl. G09G 5/00

(52) U.S. Cl. 345/629

(57) ABSTRACT

A method of processing stereoscopic 3D images for display on a 2D display device and viewing using eyewear having a first lens and a second lens includes receiving a first content image stream and an associated second content image stream of common imagery from an image source, where each content image stream has a plurality of image frames. Frame control information is associated with each of the image frames, and the frames of the first and second content streams are interleaved in sequential order to form an interleaved image stream.

### CROSS REFERENCE TO RELATED APPLICATION

This patent application claims the benefit of U.S. Provisional Application Ser. No. 60/794,277, filed Apr. 21, 2006, the contents of which are incorporated by reference herein.

### BACKGROUND OF THE INVENTION

1. Field of Invention

The present invention relates to stereoscopic three-dimensional (3D) imaging, and more specifically to a method and apparatus for processing, displaying, and viewing stereoscopic 3D video on a variety of two-dimensional electronic display devices.

2. Description of the Related Art

Stereoscopic 3D media content, whether film, video or computer-generated, is most often comprised of two discrete, time-synchronized image streams—a left image stream and a right image stream. Such dual stereoscopic 3D image streams are not well suited for display and viewing on two-dimensional (2D) electronic viewing devices such as televisions and computers.

Full-color, true stereoscopic 3D video cannot be viewed on two-dimensional electronic display devices without some form of stereoscopic 3D image processing combined with the use of electronic active eyewear. The most commonly used full-color stereoscopic 3D video image processing technique and display format is known as “field sequential 3D” or “interlaced 3D.” Field sequential 3D is a stereoscopic 3D video technique for display on standard definition, interlaced television displays. Display of the interlaced 3D images requires dedicated image processing and eyewear controller hardware, such a television set-top box. Viewing requires electronic active eyewear which is synchronized to the horizontal synchronization signal of the television. This means that the electronic active eyewear is dependent on compatible hardware in the display device to view the 3D images.

It has been observed that the present 3D video techniques provide 3D images having poor spatial, temporal, and chroma resolution. Complaints of eye fatigue when viewing interlaced 3D are common. Moreover, technical deficiencies, combined with limited availability of interlaced 3D video content, have resulted in poor commercial acceptance of interlaced 3D.

It is an object of the present invention to provide a method for processing, displaying, and viewing stereoscopic 3D images in various digital video formats and at various resolutions that are compatible with a variety of two-dimensional electronic display devices without the requirement for dedicated television set-top boxes, special computer graphics cards, or other similar devices. It is a further object of the invention to provide viewers with a stereoscopic 3D display and viewing method that is user-friendly, reliable, less costly, and of significantly higher quality than is presently available.

### SUMMARY OF THE INVENTION

The disadvantages associated with the prior art are overcome by the present invention which provides an efficient method and apparatus for both the capture and generation of new stereoscopic 3D content and for the conversion of existing dual-stream stereoscopic 3D media content and stereoscopic 3D media content comprised of discrete left and right image pairs, such as, for example, the so-called “over-and-under” single film strip stereoscopic 3D method used for many 35 mm 3D motion pictures so that such 3D content can be displayed and viewed on a variety of 2D electronic display devices.

Using the discrete left image stream and the discrete right image stream from a stereoscopic 3D media source, in one embodiment, an image processing device or controller (e.g., an “Interleaver”) constructs a new, single, interleaved, digital video stream comprised of alternating left and right images, by sequentially copying all images from the left and right source image streams. During the interleaving process, each new image or “frame” in the interleaved video stream is encoded (i.e., identified) with indicia as either being a left frame or a right frame, corresponding to the source images. The code employed may be SMPTE time code, metadata, or another coding method. The code may be carried on the video channel and/or on one or more of the audio channels on each frame of the interleaved video stream.

Where previously existing stereoscopic 3D media is used as the stereoscopic 3D source images to be interleaved, these source images are not altered or transformed in any way during the interleaving process because the interleaved stereoscopic 3D video stream is constructed by making copies of the source images.

The single, interleaved video stream is comprised of the sum of all frames copied from both the left or right image sources, which were captured at or generated for playback at n frames per second (fps)—(where “n” is an element of the set of positive rational numbers). Therefore, the interleaved video stream must be played out and displayed at 2 n fps or it will appear to be moving at one-half normal speed, creating an unnatural slow-motion effect. For example, if the original stereoscopic 3D images were captured at 29.97 frames per second, it is necessary to display the interleaved video stream at twice that fps rate, i.e. 59.94 fps.

The Interleaver can take the form of hardware, software, or a combination of both. The Interleaver can be integrated into the stereoscopic 3D imaging source (e.g., a stereoscopic 3D camera, computer, and the like). In another embodiment, it can be a separate, stand-alone device that can be connected to stereoscopic 3D cameras, video tape recorders, digital disk drives, computers, telecine devices, and other devices capable of generating or playing out stereoscopic 3D images. Alternatively, it can be a computer or device software application. Thus, the process of interleaving can be performed “live” in a camera, or as a post-production process.

Only in the case of live display of the interleaved video is the Interleaver an active component of the display process. After the interleaved video has been recorded, the Interleaver is not necessary for subsequent display and viewing.

In one embodiment, the interleaved video is displayed and viewed according to the following process: the interleaved video is processed into a digital, high definition, progressive scan video format appropriate for a display device. For example, high definition video formats can include 480 p/59.94 fps, 480 p/60 fps, 720 p/50 fps, 720 p/59.94 fps, 720 p/60 fps, 1080 p/59.94 fps, 1080 p/60 fps, among other standard or customized video formats.

The interleaved video having embedded LR-code for eyewear activation and synchronization is sent to a display device, where the interleaved video is displayed on a display device and the code (frame control information) is sent to an electronic control signal emitter (CSE). The (CSE) sends eyewear activation and synchronization signals to a receiver in the electronic active eyewear. The activation and synchronization signals received by the eyewear control the left/right open/close visual sequences of the eyewear. A viewer using the eyewear can thus perceive a full-color, true stereoscopic 3D, and near-flicker-free image on a two-dimensional display device.

In one embodiment, a method of processing stereoscopic 3D images for display on a 2D display device and viewing using eyewear having a first lens and a second lens includes receiving a first content image stream and an associated second content image stream of common imagery from an image source, where each content image stream has a plurality of image frames. Frame control information is affixed to each of the image frames, and the frames of the first and second content streams are interleaved in sequential order to form an interleaved image stream.

In another embodiment of a method of viewing stereoscopic 3D images from a sequence of interleaved frames originating from first and second content image streams, where the 3D images are displayed on a 2D display device and viewed using eyewear having a first lens, a second lens and a receiver, the method includes receiving frame control information associated with each frame image from the interleaved frames. The frame control information associated with each image frame of the first content image stream enables vision through the first lens and disables vision through the second lens of the eyewear while the frame imagery associated with the first content stream is contemporaneously being displayed on the display device. In response to frame control information associated with the second content image stream, vision through the second lens is enabled and vision through the first lens of the eyewear is disabled while frame imagery associated with the second content stream is contemporaneously being displayed on the display device.

In yet another embodiment of method of displaying and viewing stereoscopic 3D images from a sequence of interleaved image frames originating from first and second content streams, where the 3D images are displayed on a 2D display device and viewed using eyewear having a first lens, a second lens and a receiver, the method includes receiving the sequence of interleaved image frames, where each image frame has associated frame control information affixed therewith. The frame control information is extracted from the frame imagery, and a frame image is contemporaneously transferred to the display device while transferring the associated frame control information to the eyewear. The frame control information synchronizes the eyewear lenses with the displayed sequence of image frames to permit stereoscopic three-dimensional viewing of the sequence of images frames.

### BRIEF DESCRIPTION OF THE DRAWINGS

The teachings of the present invention can be readily understood by considering the following detailed description in conjunction with the accompanying drawings in which:

FIG. 1 is a functional block diagram of a stereoscopic three-dimensional (3D) video system suitable for implementing the present invention;

FIGS. 2A and 2B collectively depict a flow diagram of a method for processing, displaying and viewing stereoscopic 3D images in accordance with the principles of the present invention;

FIG. 3 is a schematic diagram of an interleaving process of left and right video streams in accordance with the method of FIGS. 2A and 2B;

FIGS. 4A and 4B are functional block diagrams illustrating interleaved stereoscopic 3D video images being contemporaneously displayed and viewed in accordance with the method of FIGS. 2A and 2B; and

FIG. 5 is a schematic diagram of electronic active eyewear suitable for implementing the present invention.

To facilitate an understanding of the invention, the same reference numerals have been used, when appropriate, to designate the same or similar elements that are common to the figures. Unless stated otherwise, the features shown and described in the figures are not drawn to scale, but are shown for illustrative purposes.

### DETAILED DESCRIPTION OF THE INVENTION

The present invention is a method and apparatus for generating, processing, and viewing stereoscopic three-dimensional (3D) video images on two-dimensional (2D) digital displays that operate under various formats, such as high definition television HDTV, standard definition television (SDTV), and the like. The stereoscopic three-dimensional (3D) video images are formed from left and right video streams, which include frames of video images, such as photographed images. Each frame is affixed with frame control information, such as a frame identifier and time indicator, and optionally, encoded (i.e., compressed) in a conventional manner. The identified (compressed or non-compressed) frames from each channel (i.e., left and right stereoscopic 3D images) are then interleaved to form a single interleaved image stream. Thus, the interleaved image stream includes an alternating sequence of right and left frames, where each frame includes a frame identifier and a time stamp.

The interleaved image stream can then be transferred to a play-out device, such as a DVD, among other play-out devices for viewing. In order to view the three-dimensional effects in the interleaved image stream on the display, the play-out device parses each frame to extract the frame control information (frame identifier and time indicator information), and contemporaneously transfers frame images to the display device while the frame control information is sent to electronic active eyewear worn over the eyes of the viewer. The frame control information is preferably transferred to the active eyewear wirelessly. When a frame originating from the right image stream is being displayed, the active eyewear enables viewing of the corresponding displayed frame through the right lens while disabling viewing through the left lens of the eyewear. Similarly, when the next frame in the interleaved image stream, i.e., the left frame, is displayed on the display device, the active eyewear enables viewing through the left lens while disabling viewing through the right lens of the eyewear. The active eyewear alternates between enabling and disabling the right and left lenses as the corresponding right and left frames of the interleaved image stream are displayed on the display device.

Accordingly, the electronic active eyewear is synchronized via the frame control information with the frames that are displayed from the interleaved image stream. The synchronization by the control information enables the viewer to experience the 3D effects of the displayed video images. In this manner, the synchronization method is advantageously derived from the video frames themselves, as opposed to the current dependency on hardware characteristics or operations, such as the synchronization signal from a television set.

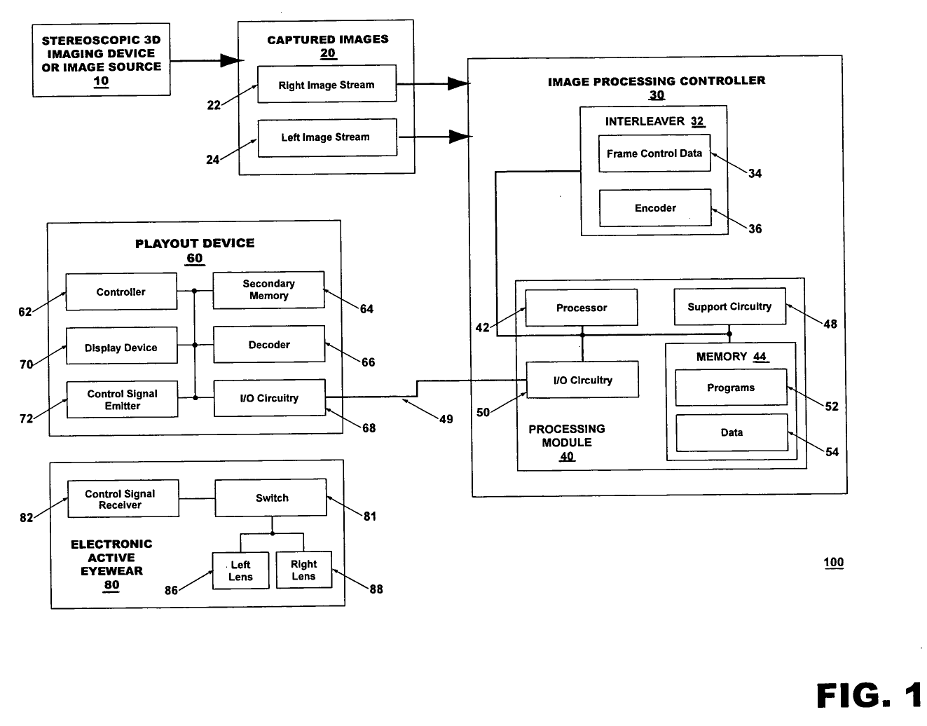

Referring to FIG. 1, an illustrative functional block diagram of a stereoscopic three-dimensional (3D) video system 100 of the present invention is shown. The stereoscopic 3D video system 100 comprises a stereoscopic 3D imaging device or source 10, captured images 20, at least one image processing controller 30, a play-out device 60, and electronic active eyewear 80 for enabling viewing of stereoscopic three-dimensional video images.

The stereoscopic 3D imaging device or source 10 can be any one of a 3D camera, a 3D film or video, computer generated 3D images, among other devices that can capture three-dimensional video images. Alternatively, the stereoscopic 3D source can illustratively be a motion picture, such as an archived film that was originally produced using three-dimensional imaging techniques. For example, films such as the “Creature from the Black Lagoon” and “JAWS 3” were filmed in 3D using discrete left and right stereoscopic 3D image pairs to generate three-dimensional effects.

The captured images 20 include a first (e.g., right) image stream 22 and a second (e.g., left) image stream 24. The two image streams are stored (i.e., recorded) illustratively in a memory device of the stereoscopic 3D camera or other computer device. The left and right image streams are each formed by a sequence of video frames that capture a view or scene being photographed or recorded at a particular time and focal point (angle) by the stereoscopic 3D imaging device 10. For example, a stereoscopic 3D camera includes left and right lenses that are preferably spaced approximately 65 mm apart to correspond with the average distance between the left and right eyes of a person.

In one embodiment, the captured right and left image streams 22 and 24 are stored directly in the memory of the stereoscopic 3D imaging device 10. For example, a conventional stereoscopic 3D camera system includes well-known hardware and/or software means for recording and storing the captured image streams 22 and 24.

The image processing controller 30 comprises a processing module 40 and an interleaver module 32, which includes a frame identifier and time indicator module (i.e., frame control data or information) 34 and an encoder module 36. One skilled in the art will appreciate that these modules can be in the form of hardware, software, or a combination thereof. The controller 30 is suitable for controlling processing operations between the plurality of modules to form a single interleaved video image stream from the two captured (i.e., right and left) image streams 22 and 24. Although the processing module 40 and interleaver 32 are shown directly interconnected in a single unit, such as in a stereoscopic 3D camera, one skilled in the art will appreciate that the image processing controller 30 is a functional representation and that some of the modules, such as the interleaver 32 or its component modules (i.e., encoder 36 and/or frame control information 34 modules) can be remotely located from each other and exchange information via wired or wireless communication links. Preferably, the interleaver 32, encoder 36 and frame control information 34 modules are integrated as a single device.

The processing module 40 comprises a processor 42 as well as memory 44 for storing various control programs 52 and data 54. The processor 42 may be any conventional processor, such as one or more INTEL® processors, among others. The memory 44 can include volatile memory (e.g., RAM), non-volatile memory (e.g., disk drives, flash memory, programmable memory), among other memory devices, and/or combinations thereof. The processor 42 cooperates with support circuitry 48, such as power supplies, clock circuits, cache memory, among other conventional support circuitry, to assist in executing software routines (e.g., one or more steps of method 200) stored in the memory 44.

As such, it is contemplated that some of the process steps discussed herein as software processes may be implemented within hardware, for example, as circuitry that cooperates with the processor 42 to perform various steps. It is noted that an operating system (not shown) and optionally various application programs (not shown) can be stored in the memory 44 to run specific tasks and enable user interaction. The controller 40 also comprises input/output (I/O) circuitry 46 that forms an interface between various functional elements communicating with the image processing controller 30. Communications between the various components of the processing module 40 are facilitated by one or more communication (e.g., bus) lines 48 in a conventional manner.

As noted above, the image processing controller 30 is responsible for producing an interleaved image stream from the frames of the right image stream 22 and left image stream 24, which are illustratively stored in designated memory of the stereoscopic 3D image source device 10. Preferably, the frames from the right and left image streams are encoded by the encoder 36, although compression of the frames is not required for implementing the present invention. Encoding techniques can include, for example, forward and backward predictive techniques to form I, P and B frames, among other conventional lossy and lossless compression encoding techniques.

The frame control information module 34 provides a frame identifier that preferably identifies the frame position in the captured image stream. In one embodiment, the frame identifier and time indicator is represented by a string of eight characters that can either be prefixed or appended to the image information forming the frame. For example, the frame identifier can include indicia of the right or left frame and a frame sequence number, such as R1, L1, R2, L2, and so forth for each frame. A time stamp is also provided with the frame identifier. Preferably, the time stamps provide the time in terms of hours, minutes and seconds at which the frame has been copied from the source image streams 22 and 24 prior to the right and left image frames being interleaved.

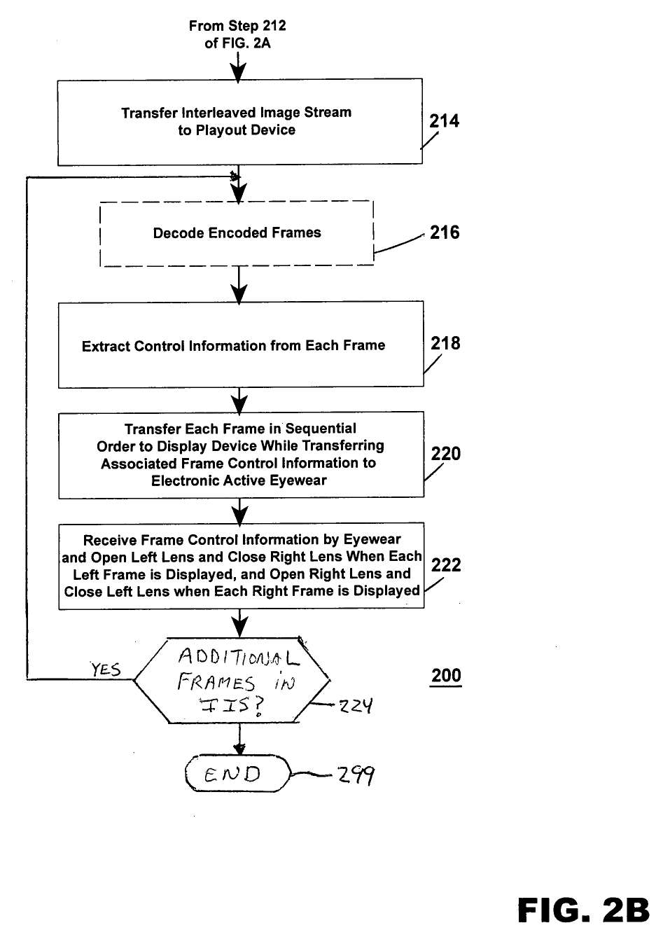

The interleaver module 32 sequentially copies all frame images from the left and right source image streams and interleaves the right and left image frames having the frame identifiers and time indicators into a single interleaved image stream. Thus, the single interleaved image stream can be either compressed or non-compressed stereoscopic 3D imagery, where the right and left frames are slotted in sequential order, such as R1, L1, R2, L2, and so forth (see FIG. 3). One skilled in the art will appreciate that the first frame in the sequence can be either the right frame RI or left frame L1 in the interleaved image stream. Once the interleaved image stream is formed, it is stored in a primary memory device, such as the data portion 54 of memory 44 of the controller 30.

The captured stereoscopic 3D images can be played out almost immediately, e.g., “live” viewing, or archived for future playback. For example, where live broadcasts are desired, once the interleaved image stream is formed, it is immediately sent to one or more play-out devices 60, such as a digital television, and the like. For example, a multi-media content provider, such as a television broadcast company and the like, transmits the interleaved image stream to a distribution center such as a cable or satellite company, which transmit the interleaved image stream to their customers in a conventional manner. One skilled in the art will appreciate that there can be a slight delay (usually a few seconds) from the time the image is initially captured by the source device 10 to the time the image is viewed on the display device. Further, broadcasting regulations may mandate a broadcast delay for censorship or other purposes.

Alternatively, where the captured content is not designated for live viewing, the interleaved image stream can be stored in the memory 44 of the processing controller 30, or more preferably, sent to a secondary storage device 64, such as a content server, a play-out device (e.g., a DVD) or any other secondary storage device.

When a user desires to view the stereoscopic 3D images formed by the interleaved image stream illustratively stored on the secondary storage device, the user can retrieve the interleaved image stream from a play-out device 60, such as a DVD player, computer, and the like. The play-out device 60 shown in FIG. 1 is a functional block diagram representing the general components to extract the frame control information and display the interleaved image stream in a sequential order on the display device 70.

In one embodiment, the play-out device 60 includes a controller 62, secondary memory 64, a decoder 66, I/O circuitry 68, a display device 70 and a control signal emitter 72. The controller 62 controls communications between the various components of the play-out device 60. The controller 62 can include a processor, memory, support circuitry and other components that operate in a similar manner as the processing module 40 of the image processing controller 30. The decoder decompresses the frames of the interleaved image stream, as required, and in one embodiment, extracts the frame and time identifying information, which is sent to the control signal emitter 72, as discussed below in further detail.

The secondary memory 64 can be located and coupled locally to or externally from the play-out device 60. For example, if the play-out device is a DVD player, then the secondary memory 64 includes the DVD storing the interleaved image stream. Alternatively, if the play-out device is a computer, then the secondary memory 64 could be a content server from a content provider or a disk drive on the computer. The I/O circuitry 68 receives, via conventional communication medium 49, the interleaved image stream, for example, from the primary memory 44 of the image processing controller 30 during live viewing or the secondary memory 64 in instances where the stereoscopic 3D images are archived.

The present invention is applicable to a variety of 2D electronic display devices 70, such as digital televisions, computers, digital projection systems, personal digital media players, cellular phones, video game systems, head-mounted stereoscopic visual display systems, and other devices. The present invention is ideal for use with current digital television formats capable of displaying progressive scan video, especially a high definition television (HDTV).

The screen display of the display device 70 can employ Liquid Crystal Display (LCD), Liquid Crystal on Silicon (LCoS), Surface-Conduction Electron Emitter Display (SED), Digital Light Processing (DLP), Plasma Display Panel (Plasma), Organic Light Emitting Diode (OLED), or other electronic viewing screen display technologies. Other 2D electronic display technologies may be compatible with the invention, provided that they are able to display progressive scan interleaved video 302 at 2 n fps in the desired video format, receive and carry the control data signal embedded in the interleaved video stream 302, and have an integrated control signal emitter (CSE) 72 or can be connected to an external CSE 72. In a preferred embodiment, LCD, Plasma, and DLP screen displays 70 have been shown to provide high-quality performance, in contrast to Cathode Ray Tube (CRT) screen displays that use a scanning technique which is incompatible with the present invention.

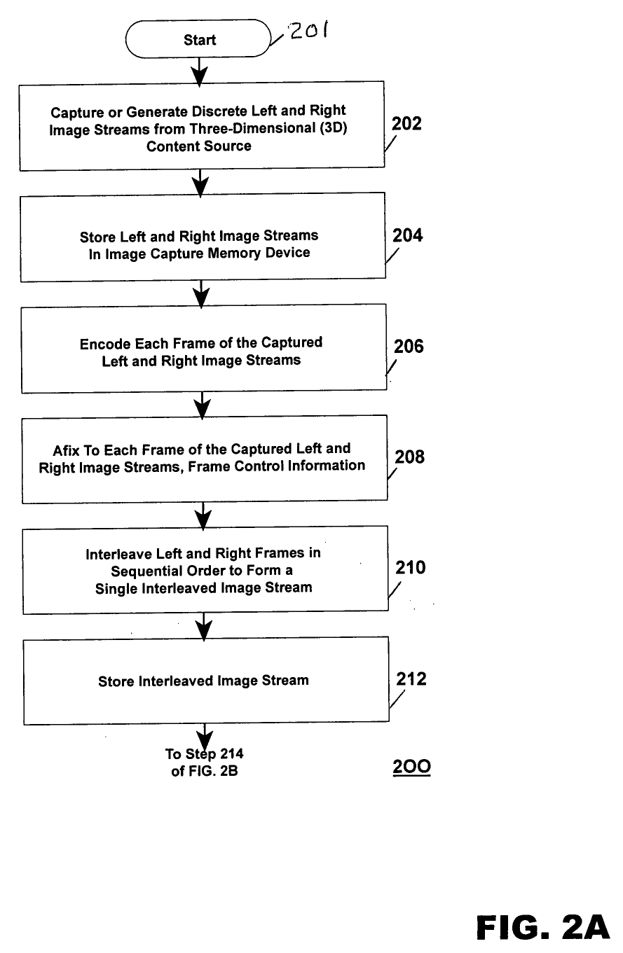

The control signal emitter 72 sends the frame and time identification information from each interleaved frame to the display device 70 and the electronic active eyewear 80 in a synchronized manner, as discussed in below in further detail with respect to FIGS. 2A-4B. Although the CSE 72 and decoder 66 are shown as separate components, both can be combined to contemporaneously decode and extract the frame imagery as well as the frame control information (i.e., frame identifiers and time codes).

The CSE 72 preferably includes wireless communications circuitry for transmitting the frame control information to the active eyewear 80. The wireless communications circuitry can include infrared (IR) communication, BLUETOOTH wireless communications, among other wireless or wired communication channels.

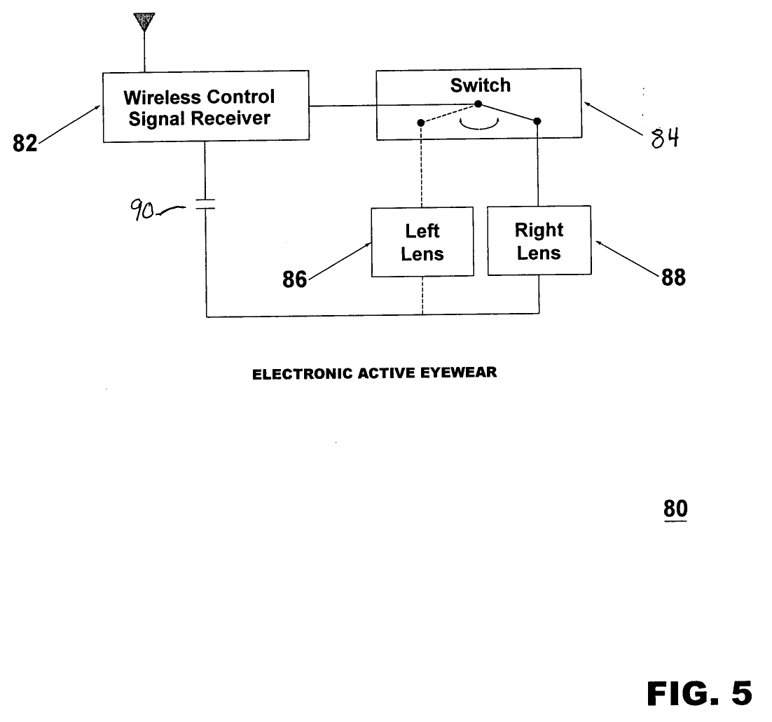

The electronic active eyewear 80 comprises a left lens 86, a right lens 88, a control signal receiver (CSR) 82, a switching circuit 84, and a replaceable or rechargeable battery power supply 90, as schematically illustrated in FIG. 5. The CSR 82 receives the frame identifier and time indicator information, which functions as a synchronization signal to alternatively activate and deactivate the right and left lenses through the switch 84. Preferably the left and right lenses 86 and 88 are formed by liquid crystal displays (LCDs), which are alternately switched between opaque or transparent states in response to sync signal information from the CSE 72.

In particular, the present invention synchronizes the transparency of the left and right lenses while the associated left and right frame images are displayed on the display device 70. For example, when the first right frame R1 is being displayed on the display 70, the associated sync signal causes the switch 84 to apply a predetermined voltage to the right lens 88, thereby making the right lens opaque, while contemporaneously removing any previously applied voltage to the left lens 86, thereby making the left lens transparent. When the next frame, i.e., the left frame L1 of the frame sequence in the interleaved image stream is displayed on the display 70, the sync signal causes the switch 84 to apply the predetermined voltage to the left lens 86, thereby making the left lens opaque, and contemporaneously removing the predetermined voltage applied to the right lens 88, thereby making the right lens transparent. Each time a left or right frame is displayed on the display 70, the left and right lenses of eyewear 80 are synchronized to alternately change between visual states of being opaque and transparent, as described below in further detail with respect to the method 200 of FIGS. 2A and 2B.

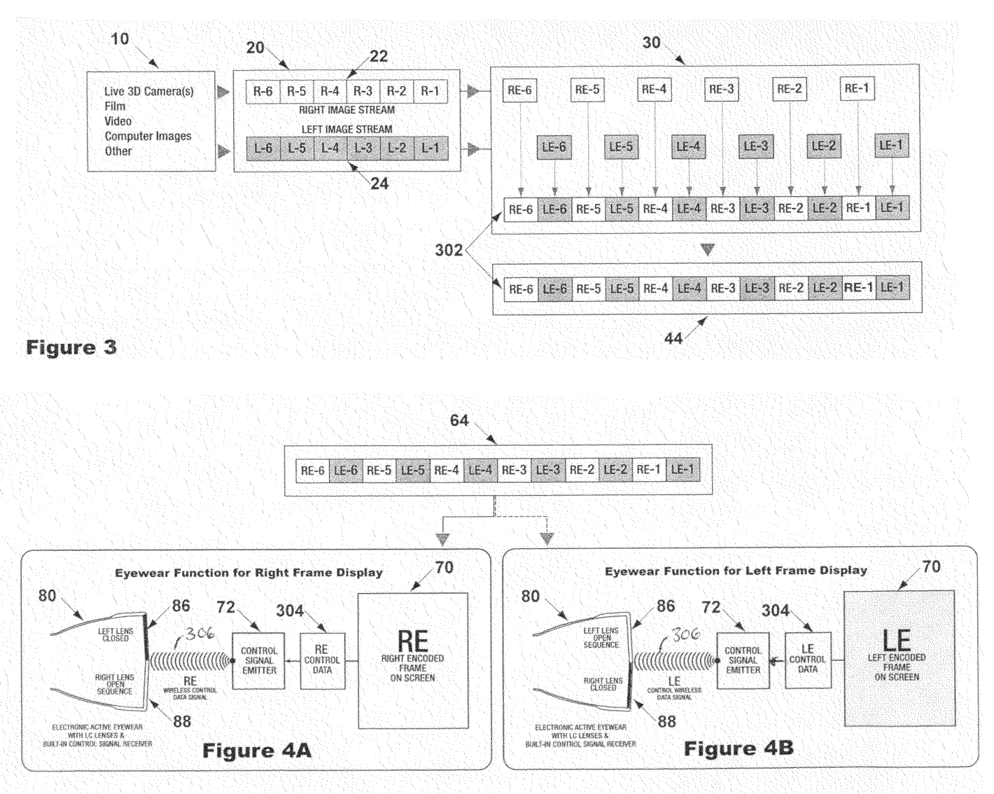

FIGS. 2A and 2B depict a flow diagram of a method 200 for processing, displaying, and viewing interleaved stereoscopic 3D images 30 on a 2D display device. The flow diagram of FIGS. 2A and 2B should be viewed in conjunction with the schematic diagrams of FIGS. 3, 4A and 4B.

Referring to FIG. 2A, the method 200 starts at step 201 and proceeds to step 202, where discrete left and right image streams 22 and 24 are generated from a three-dimensional (3D) content source, such as an electronic stereoscopic 3D camera, a 3D film, among other content sources. The source images 20 are comprised of two discrete streams of images, i.e. a left image stream 24 and a right image stream 22, which at step 204, are stored in an image capture memory device in the source device 10.

Referring to FIG. 3, the left source video stream 22 is formed by a sequence of frames L1-L2-L3 and so forth, while the right source image stream 24 is similarly formed by a sequence of frames R1-R2-R3 and so forth. Processing of the source image streams 22 and 24 is performed by the image processing controller 30, where at step 206, the frames of each source image stream are optionally encoded into compressed images LE1 . . . LEp and RE . . . REp, where p is an integer greater than 1.

At step 208, the frame control information is affixed to each frame. Preferably, the frame control information includes an eight digit stream identifier and time indicator. For example, the frame identifier can include stream source and frame sequence number such as L1, L2, R1, R2 and the like, where L and R are the stream identifiers, and 1, 2, . . . represent the sequence number of the frames in the streams. The time is provided in hours, minutes, and seconds, as discussed below with respect to step 210 of method 200.

At step 210, the left and right frames are interleaved in sequential order to form a single interleaved image stream 302. It is noted that the frames per second rate of the source images 20 may be other than n fps, but in these circumstances the source images 20 must be converted to a video format capable of n fps prior to the interleaving process. This will most commonly apply to stereoscopic film, video, or computer-generated images captured or intended for playback at fps rates of 23.98 fps or 24 fps, which is the standard fps rate for movies. For 23.98 fps and 24 fps source images, a “3:2 pulldown” conversion process commonly used in the television and film industry can be employed to convert the 23.98 or 24 fps source images to 29.97 fps video source images, because subsequent display of the interleaved video stream (IVS) 302 can require an industry standard video format capable of displaying images at 2 n fps. It is noted that there are currently no standard video formats capable of displaying 23.98 fps video at 47.95 fps or 24 fps video at 48 fps, but 59.94 fps (twice 29.97 fps) is an industry-standard video fps rate. It is noted that alternative video formats that may be developed should be readily compatible with the present invention as well as with existing and future display devices.

Referring to FIG. 3, the interleaver 20 combines the two separate source image streams 20 by constructing a new, single, interleaved video stream (L-1-R-1-L-2-R-2-L-3-R-3 and so forth) 302 with images copied alternately from the right and left image stream sources 20. Each frame of the interleaved video 302 is affixed or encoded with either “LEFT EYE (LE)” or “RIGHT EYE (RE)” eyewear activation and synchronization information. One possible embodiment uses SMPTE (Society of Motion Picture and Television Engineers) time codes, and the time codes for each frame are embedded in each frame as shown in FIG. 3. The SMPTE time code takes the form of an eight-digit twenty-four hour clock. The count consists of 0 to 59 seconds, 0 to 59 minutes, and 0 to 23 hours. Each second is subdivided into a number of frames, which may be varied to match the various frame rates employed for different video formats.

In the embodiment using SMPTE time codes, all even-numbered frames within the interleaved video stream 30 are designated as LE frames and all odd-numbered frames are designated as RE frames, as shown in FIG. 1. Thus, in this example, the sequence of time codes is LE1-RE1-LE2-RE2 and so forth.

In addition or alternatively to SMPTE time coding, metadata or other encoding technologies may be used as a primary activation and synchronization coding method or for redundant coding back up. Further, one skilled in the art will appreciate that all even-numbered frames can be designated for RE frames while all odd-numbered frames are designated for LE frames.

If the source images 20 are uncompressed, the interleaved video 302 will also be uncompressed. Alternatively, uncompressed source images may be compressed during the interleaving process using industry standard or customized video compression codecs. If the source images 10 are compressed, the interleaved video 302 will embody the same compression as the source. Additional compression codecs may be applied to interleaved video that already embodies compression. The compression processes may be performed either concurrent with the interleaving process or at a later time.

The interleaved video 302 is converted to the desired video format(s), e.g. 480 p/59.94 fps, 480 p/60 fps, 720 p/50, 720 p/59.94 fps, 720 p/60 fps, 1080 p/59.94 fps, 1080 p/60 fps, for recording to a video storage device 64 or direct play-out to a display device 70, e.g. high definition television, computer, and the like. This video format conversion process can be performed concurrent with the interleaving process or later as a separate process.

At step 212, the interleaved video image 302 is stored in a primary storage device 44, such as the memory 44 of a camera, and at step 214 of FIG. 2B, the interleaved image stream 302 is transferred to the play-out device 60. For recorded video play out and display applications, the interleaved video (LE-1-RE-1-LE-2-RE-2-LE-3-RE-3 and so forth) 302 is stored in a secondary video storage device 64 associated with the play-out device 60 (e.g., a DVD, computer disk drive, content server and the like) for subsequent play-out at 2 n fps to the display device 70. For live display applications, the interleaved video 302 need not be sent to the video storage device 64, but rather can be sent directly from the primary memory device 44 to the play-out device 60 and immediately played out at 2 n fps on the display 70. In either case of live or subsequent play-out of archived images, if the interleaved image stream 302 is encoded, then at step 216, the decoder 66 decodes the encoded left and right frames in sequential order, and at step 218, extracts the frame control information (i.e., frame identifier and time indicator information) that is affixed to each frame.

At step 220, the frame control information of a single frame is transferred, for example by a wireless communications medium, to the eyewear 80, as the frame imagery of the frame is displayed on the display device 70. That is, the frame control information is transferred contemporaneously with the corresponding frame imagery being displayed.

Referring to FIG. 1, the CSE 72 is integrated into or is externally connected to the play-out device 60, such as the display device 70. Referring now to FIGS. 4A and 4B, in one embodiment, the CSE 72 receives and decodes the frame control data (i.e., the time codes) 304 on the interleaved video 302 and converts them to wireless frame control signals 306 containing instructions for the activation and synchronization of the lenses in the eyewear 80. In the embodiment of FIGS. 4A and 4B, the wireless control signal 306 contains a frame sequence of LE1-RE1-LE2-RE2 and so forth. The method 200 then proceeds to step 222.

At step 222, the wireless control signals sent to the eyewear 80 activate and synchronize the open/close sequence of the eyewear 80 lenses so that the left frames of the interleaved video 30 are visible exclusively to the viewer's left eye, and the right frames are visible exclusively to viewer's right eye. The wireless control signals are sent to the electronic active eyewear 80. The wireless control signals can be wide angle or omni directional to control a plurality of eyewear 80, or directional or otherwise keyed to control one or a subset of eyewear 80 within the reach/range of the wireless control signal.

Referring to FIG. 5, the electronic active eyewear 80 is preferably a battery powered, electronic Liquid Crystal (LC) viewing glasses. The eyewear 80 includes a receiver 82, a switch 84, a battery 90, a left lens 86 and a right lens 88. Preferably the receiver 82 is a wireless receiver that employs infrared (IR), radio frequency (RF), or other suitable technologies for receiving the wireless control signals from the CSE 72. The receiver 82 converts the wireless control signals from the CSE 72 into an output signal that is sent to the switching circuitry 84, which in turn activates (closes) one of the lenses.

An LC lens becomes opaque in response to applying a voltage, and becomes transparent when the voltage is removed. The switch 84 provides the voltage signal to one of the integrated left and right LC lenses 86 and 88 at a time to either admit or block the light through the lenses in synchronization with the frame images on the display device 70. The open and close sequence of the LC lenses is a function of the voltage applied to the LC lens as determined by the wireless control signal received from the CSE 72. Thus, both LC lenses of the eyewear 80 are individually controllable via the voltage applied to the LC lens so as to act like a shutter of a camera. One skilled in the art will appreciate that other embodiments of the electronic active eyewear 80 can be used instead of those employing LC technology.

Referring to the illustration in FIGS. 3, 4A and 4B, the wireless control signals are affixed to the illustrative interleaved frame image sequence LE1-RE1-LE2-RE2, and the LC lenses will open in the order of Left-Right-Left-Right and so forth. At the same time, the display device 70 displays the corresponding frame images according to the time code, that is, LE1-RE1-LE2-RE2 and so forth. Since each frame of the interleaved video 30 is displayed for ½ n seconds on the display device 70, while a left frame is displayed on the display device 70 (½ n seconds), the right LC lens remains in a fully closed (opaque) state and the left LC lens remains in a fully open state (transparent). On the other hand, while a right frame is displayed (½ n seconds), the right LC lens remains in a fully open state and the left LC lens remains in a fully closed state.

In another embodiment, while a left frame (LE) is displayed (½ n seconds), the right lens remains in a fully closed state (opaque), but the left lens alternates (i.e., pulses) between a fully closed and open states m times (where “m” is an element of the set of positive integers). In the same way, while a right frame (RE) is displayed (½ n seconds), the left LC lens remains in a fully closed state but the right lens alternates between a fully closed and open states m times. To minimize any perception of image flicker, the rate at which the LC lenses alternate between their open and closed states during each sequence (2 mn times per second) is sufficiently high to be almost imperceptible by the viewer wearing the eyewear (80).

In one embodiment, even-numbered frames of the interleaved video 302 and odd-numbered frames of the interleaved video 302 correspond to LE and RE time codes respectively. Thus, the viewer's left eye can see even-numbered frames only through the left lens when the even-numbered frames are displayed on the display device 70, and the viewer's right eye can see odd-numbered frames only through the right lens, when the odd-numbered frames are displayed on the display device 70. The parallax difference between the left and right stereoscopic 3D views simulates the slightly different perspective views that each eye naturally receives in binocular vision.

Preferably, the LC lenses open and close at a minimum frequency of approximately 120 Hz, thereby minimizing perceptible flicker. The open/close frequency must be a multiple of the frame rate of the interleaved video. For example, for interleaved video 302 with a 59.94 fps rate, the open/close frequency of the LC lenses must be twice the frequency (i.e., 119.88 Hz) to maintain synchronization between the interleaved video 302 and the eyewear 80. The rapid open/close rate of the eyewear 80, combined with the rapid refresh of the alternating left and right stereoscopic 3D views, creates the illusion of smooth, continuous motion, and three-dimensional depth perception. As a result, the viewer can perceive full color, near-flicker-free, high definition, true stereoscopic 3D images on a variety of 2D electronic display devices 70.

Referring to FIG. 2B the method 200 proceeds to step 224. At step 224, a determination is made whether there are additional frames from the interleaved image stream 302 that have not been displayed and viewed on the display device 70. If the determination is answered positively, the method 200 proceeds to step 216, where steps 216 through 224 are repeated until at step 224, the determination is answered negatively, where at step 299 the method 200 ends.

Accordingly, the present invention provides 3D images having high-quality spatial, temporal, and chroma resolution, such that complaints of eye fatigue when viewing interlaced 3D are alleviated. Further, the present invention provides methods for processing, displaying, and viewing stereoscopic 3D images in various digital video formats and at various resolutions that are compatible with a variety of two-dimensional electronic display devices and without the requirement for dedicated television set-top boxes, special computer graphics cards, or other similar devices. That is, the encoding of each image frame with frame control information, such as a frame identifier and time stamp, enable the synchronization of the lenses of the eyewear with the corresponding frame image being displayed on the 2D display device. In this manner, the hardware dependency to generate a synchronization signal by the display device is eliminated. Thus, the present invention provides viewers with a stereoscopic 3D display and viewing method that is user-friendlier, reliable, less costly, and of significantly higher quality than is available from prior art.

Although various embodiments that incorporate the teachings of the present invention have been shown and described in detail herein, those skilled in the art can readily devise many other and varied embodiments that incorporate these teachings, and the scope of the invention is to be determined by the claims that follow.

What is claimed is:

1. A method of processing stereoscopic 3D images for display on a 2D display device and viewing using eyewear having a first lens and a second lens, comprising:
receiving a first content image stream and an associated second content image stream of common imagery from an image source, each content image stream having a plurality of image frames;
associating frame control information with each of said image frames; and
interleaving said frames of said first and second content streams in sequential order to form an interleaved image stream.

2. The method of claim 1, wherein said first and second content streams are right and left content image streams.

3. The method of claim 1, wherein said affixing frame control information comprises affixing a frame identifier and a time code.

4. The method of claim 1, wherein said first content image stream and an associated second content image stream are encoded.

5. The method of claim 1, wherein said interleaving said frames comprises encoding said image frames and frame control information.

6. The method of claim 1, wherein said interleaved image stream is broadcast as a live performance over said display device.

7. The method of claim 1, wherein said interleaved image stream is stored on a memory device for subsequent play-out over said display device.

8. The method of claim 1, further comprising the step of synchronizing, via said frame control information, display of a frame image from said interleaved image stream on said display device while contemporaneously enabling vision through one lens and disabling vision though the other lens of said eyewear.

9. The method of claim 1, further comprising the steps of:
displaying content imagery from a first frame of said interleaved image stream on said display device while contemporaneously transferring first frame control information associated with said first frame image to said eyewear; and
displaying content imagery from a second frame of said interleaved image stream on said display device while contemporaneously transferring second frame control information associated with said second frame image to said eyewear.

10. The method of claim 9, wherein said transferring of first and second frame control information comprises the step of emitting a wireless signal including said frame control information to said eyewear.

11. The method of claim 1, further comprising the steps of:
in response to receiving frame control information associated with a first frame, enabling vision through said first lens and disabling vision through said second lens of said eyewear while a frame associated with said first content image stream is being displayed on said display device, and in response to receiving frame control information associated with a second frame, enabling vision through said second lens and disabling vision through said first lens of said eyewear while a frame associated with said second content image stream is being displayed on said display device.

12. The method of claim 1, wherein said receiving a first content image stream and an associated second content image stream of common imagery comprises receiving imagery from one of a stereoscopic 3D camera, a 3D film, a 3D video, and 3D computer images.

13. The method of claim 1 further comprising transferring said interleaved first and second content image streams to a memory device for subsequent play-out by a play-out device.

14. The method of claim 1, wherein said transferring of said interleaved image stream comprises the step of storing said interleaved image stream on at least one of a DVD, a content server, at least one disk drive, a television console, computer, digital projection system, personal digital media player, cellular phone, video game system, and a head-mounted stereoscopic visual display system.

15. A method of viewing stereoscopic 3D images from a sequence of interleaved frames originating from first and second content image streams, said 3D images being displayed on a 2D display device and viewed using eyewear having a first lens, a second lens and a receiver, comprising:
receiving frame control information associated with each frame image from said interleaved frames, said frame control information associated with each image frame of said first content image stream enabling vision through said first lens and disabling vision through said second lens of said eyewear while said frame imagery associated with said first content stream is contemporaneously being displayed on said display device, and in response to frame control information associated with said second content image stream, enabling vision through said second lens and disabling vision through said first lens of said eyewear while frame imagery associated with said second content stream is contemporaneously being displayed on said display device.

16. The method of claim 15, wherein said enabling and disabling vision through said first and second lenses comprises applying a predetermined voltage to one of said lenses to block transparency, while contemporaneously removing said predetermined voltage from another of said lenses to return transparency.

17. The method of claim 16, said applying said predetermined voltage to one of said lenses comprises the step of providing an output control signal to a switch adapted to selectively provide said predetermined voltage to said first and second lenses.

18. The method of claim 17, wherein said applying said predetermined voltage from said switch comprises the step of pulsing said predetermined voltage while said corresponding image frame is being displayed on the display device.

19. A method of displaying and viewing stereoscopic 3D images from a sequence of interleaved image frames originating from first and second content streams, said 3D images being displayed on a 2D display device and viewed using eyewear having a first lens, a second lens and a receiver, comprising:
receiving said sequence of interleaved image frames, each image frame having associated frame control information;
extracting said frame control information from said frame imagery; and
contemporaneously transferring a frame image to said display device while transferring said associated frame control information to said eyewear, wherein said frame control information synchronizes said eyewear lenses with the displayed sequence of image frames to provide stereoscopic three-dimensional viewing of said sequence of images frames.

20. The method of claim 19, comprising the further step of enabling vision through said first lens and disabling vision through said second lens of said eyewear while frame imagery associated with said first content image stream is contemporaneously being displayed on said display device, and in response to frame control information associated with a second frame, enabling vision through said second lens and disabling vision through said first lens of said eyewear while frame imagery associated with said second content image stream is contemporaneously being displayed on said display device.

21. Apparatus for processing stereoscopic 3D images for display on a 2D display device and viewing using eyewear having a first lens and a second lens comprising:
means for receiving a first content image stream and an associated second content image stream of common imagery from an image source, each content image stream having a plurality of image frames;
means for associating frame control information with each of said image frames; and
means for interleaving said frames of said first and second content streams in sequential order to form an interleaved image stream.

22. Apparatus for viewing stereoscopic 3D images from a sequence of interleaved frames originating from first and second content image streams, said 3D images being displayed on a 2D display device and viewed using eyewear having a first lens, a second lens and a receiver, the apparatus comprising:
means for receiving frame control information associated with each frame image from said interleaved frames, said frame control information associated with each image frame of said first content image stream enabling vision through said first lens and disabling vision through said second lens of said eyewear while said frame imagery associated with said first content stream is contemporaneously being displayed on said display device, and in response to frame control information associated with said second content image stream, enabling vision through said second lens and disabling vision through said first lens of said eyewear while frame imagery associated with said second content stream is contemporaneously being displayed on said display device.

23. Apparatus for displaying and viewing stereoscopic 3D images from a sequence of interleaved image frames originating from first and second content streams, said 3D images being displayed on a 2D display device and viewed using eyewear having a first lens, a second lens and a receiver, the apparatus comprising:
means for receiving said sequence of interleaved image frames, each image frame having associated frame control information;
means for extracting said frame control information from said frame imagery; and
means for contemporaneously transferring a frame image to said display device while transferring said associated frame control information to said eyewear, wherein said frame control information synchronizes said eyewear lenses with the displayed sequence of image frames to provide stereoscopic three-dimensional viewing of said sequence of images frames.
